(19) United States
(12) Patent Application Publication
(10) Pub. No.: US 2026/0309923 A1
(43) Pub. Date: Oct. 8, 2026

(54) BROADBAND GRATING COUPLER

(71) Applicant: VTEC Lasers & Sensors Ltd, Eindhoven (NL)

(72) Inventors: KrishnaKant Rana, Manoharpur (IN); Jan Mink, Geldrop (NL)

(73) Assignee: VTEC Lasers & Sensors Ltd, Eindhoven (NL)

(21) Appl. No.: 19/482,713

(22) PCT Filed: May 8, 2024
(86) PCT No.: PCT/IB2024/054498

§ 371 Date: Nov. 7, 2025

Related U.S. Application Data
(60) Provisional application No. 63/500,874, filed on May 8, 2023.

(51) Int. Cl. G02B 6/34

(52) U.S. Cl. CPC G02B 6/34

(57) ABSTRACT

One illustrative device disclosed herein includes a waveguide structure positioned at the left and right portion of the structure, mirror, and buffer layer. In this example, the device also includes an apodized grating structure wherein the grating structure comprises a plurality of grating elements whose pitch changes along the length of the grating, which is able to couple in multiple wavelength and diffract out a broadband spectrum depending on the positioning of the source.

This application is a national stage application, filed under 35 U.S.C. § 371, of International Patent Application No. PCT/IB/2024054498, filed on May 8, 2024, which claims the benefit of U.S. provisional patent application Ser. No. 63/500,874 filed on May 8, 2023, each of which is incorporated herein by reference in its entirety.

### BACKGROUND

A number of applications exist for highly granular electromagnetic and light-based sensing, such as photolithography machine alignment sensing, biosensing, and lidar detection. Sensors conventionally used for this may be bulky, or multiple sensors may be needed to detect small shifts in multiple dimensions. Bulky and numerous sensors may be impractical in confined spaces, or when working with very small-scale sensing targets.

Broadband grating couplers may find a useful application in such sensing environments. Broadband grating couplers are well known in the current art, including zero-order broader bandwidth grating couplers. However, the latter require sub-100-nm minimum feature sizes, the fabrication methods for which may not currently exist or may not be practical.

There is, therefore, a need for a broadband grating coupler that provides low signal loss across a broad spectrum of electromagnetic and light-based input, which may be easily adapted for use in locations of restricted size, but which are practical and economical to fabricate using existing technologies.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a broadband grating coupler 100 in accordance with one embodiment.

FIG. 2 illustrates a cross-sectional view of an apodized grating coupler 200 in accordance with one embodiment.

FIG. 3A through FIG. 3C illustrate apodized grating structures 300 in accordance with one embodiment. FIG. 3A and FIG. 3B show top views and FIG. 3C shows a side view.

FIG. 4 illustrates the apodized grating coupler 200 of FIG. 2 used as an input coupling 400 in accordance with one embodiment.

FIG. 5 illustrates the apodized grating coupler 200 of FIG. 2 used as an output coupling 500 in accordance with one embodiment.

FIG. 6 illustrates parameters of an apodized grating structure 600 in accordance with one embodiment.

FIG. 7 illustrates grating fabrication stages 700 in accordance with one embodiment.

FIG. 8 illustrates a broadband grating coupler illuminating wafer alignment marks 800 in accordance with one embodiment.

FIG. 9 illustrates broadband input waveform characteristics 900 in accordance with one embodiment.

FIG. 10 illustrates discrete wavelength output waveform characteristics 1000 in accordance with one embodiment.

FIG. 11 illustrates a wafer alignment system 1100 in accordance with one embodiment.

FIG. 12 illustrates a conventional grating 1200.

FIG. 13A and FIG. 13B illustrate conventional grating coupling efficiency-bandwidth responses 1300.

FIG. 14 illustrates the critical angle and total internal reflection 1400.

FIG. 15 illustrates a slab waveguide 1500.

FIG. 16 illustrates a ray tracing analysis 1600.

FIG. 17 illustrates a slab waveguide analysis using Maxwell's equations 1700.

FIG. 18 illustrates diffraction from gratings 1800.

FIG. 19 illustrates guided-mode resonance (GMR) 1900.

FIG. 20A illustrates a response away from guided-mode resonance 2000a.

FIG. 20B illustrates a response at guided-mode resonance 2000b.

FIG. 21 illustrates regions of guided-mode resonance 2100.

### DETAILED DESCRIPTION

A broadband grating coupler design is disclosed herein which couples in multiple wavelengths within a range of 500 nm to 900 nm to a waveguide with a coupling efficiency of nearly 40% when using a broadband source of that range to illuminate the grating coupler. With the very same design, if the broadband light or other waveform is edge coupled, a broadband collimated beam (500 nm to 900 nm) may be emitted at a particular angle with coupling efficiency greater than 30%, thereby opening new venues for highly efficient broadband fiber-to-chip surface coupling in silicon photonics.

These results show that the novel designs disclosed herein out-perform currently available experimentally demonstrated surface couplers that overcome the efficiency-bandwidth limitation of older conventional diffraction grating designs by exploiting zero-order radiation from a subwavelength metamaterial waveguide to a tilted silicon prism. The coupling efficiency of a current state-of-the-art broadband device may be above 80% when coupled to a Single Mode Fiber 28 (SMF-28) fiber with 1-dB bandwidth beyond 90 nm.

Zero-order grating couplers with even broader bandwidths may potentially be developed in accordance with this disclosure when sub-100-nm minimum feature sizes become commonly available in silicon photonics fabrication.

Such broadband grating couplers as the disclosed may find applications in photolithographic alignment sensors, fiber coupling for coarse wavelength division multiplexing (CWDM) systems with spans greater than 200 nm, biosensors detecting broadband light-matter interaction, and other sensing methods where optical broadband is used.

The current subject matter will now be exemplified with reference to the supporting figures. Several structures are conventionally portrayed in the drawings for explanatory purposes only and so as to not disguise the current disclosure with attributes that are well understood to expert individuals skilled in the art. However, these figures are included to explain and elaborate descriptive examples of the present disclosure. Several explanatory embodiments of the disclosure are depicted below, but the disclosure is not limited thereto. With regard to these figures, various descriptive embodiments of the constructs unveiled herein will now be described with additional details.

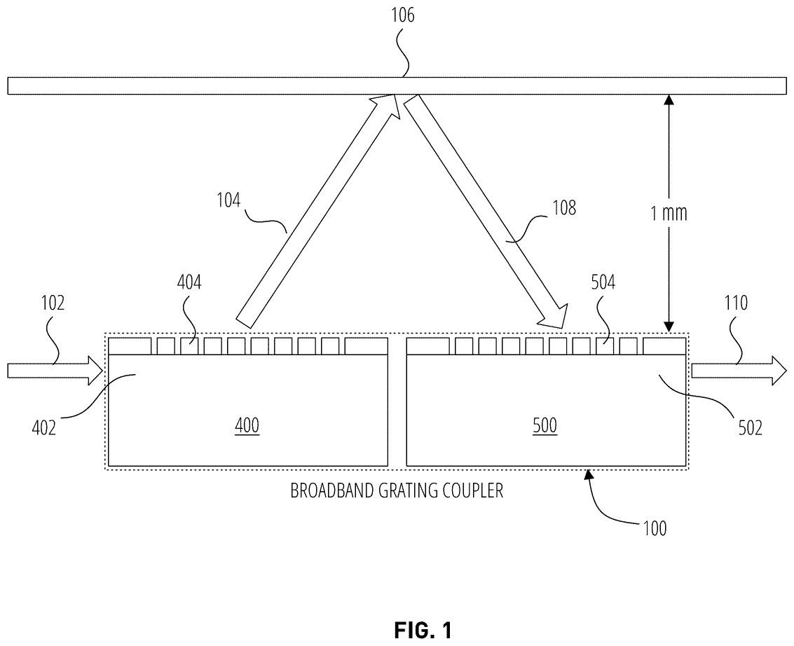

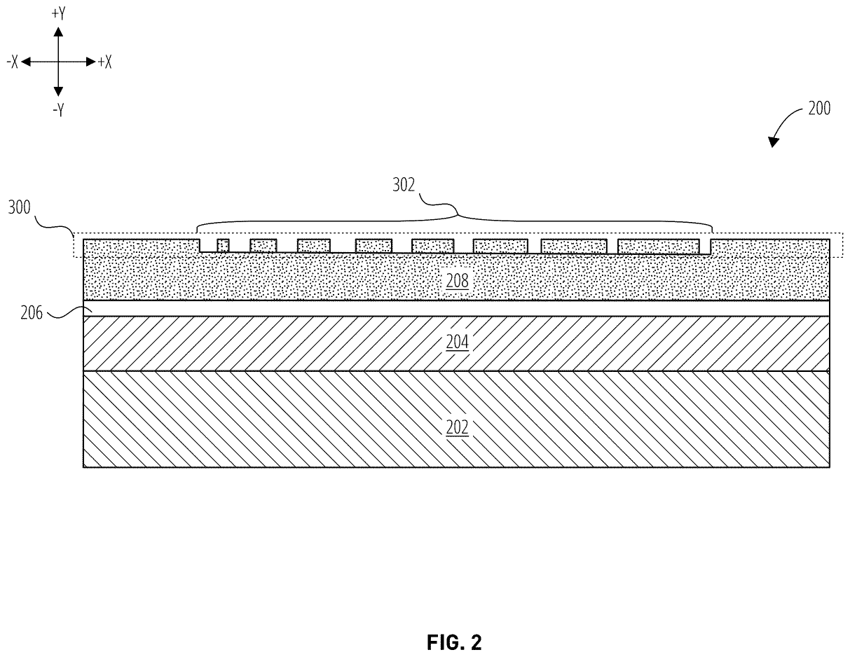

FIG. 1 illustrates a broadband grating coupler 100 in accordance with one embodiment. The broadband grating coupler 100 comprises an input coupling 400 having an input waveguide layer 402 and an input grating structure 404, and an output coupling 500 having an output waveguide layer 502 and an output grating structure 504. In one embodiment, the input coupling 400 and output coupling 500 may be photonic chips with optical fiber. Apodized grating couplers 200 such as those illustrated and described in detail with reference to FIG. 2 may be used for the input coupling 400 and the output coupling 500.

The input signal 102 may be a broadband light signal. In one embodiment, the broadband light signal may comprise light energy having wavelengths from 500 nm to 900 nm. The input signal 102 may be projected onto an edge of the input coupling 400 by, for example, a coupled fiber. The input waveguide layer 402 of the input coupling 400 may guide the input signal 102 using waveguide transmission along the length of the input coupling 400. The input signal 102 may be diffracted through the input grating structure 404 of the input coupling 400 into a resulting emitted beam 104 which may be a broadband collimated beam at a known angle of incidence upon a reflection target 106, yielding transmission efficiency >0.3. “Angle of incidence” in this disclosure refers to the angle between an electromagnetic waveform incident on a surface and the line perpendicular to the surface at the point of incidence, which may be called a normal line, surface normal, or grating normal herein. All wavelengths comprised in this beam may be emitted from the input coupling 400 at the same known angle of incidence.

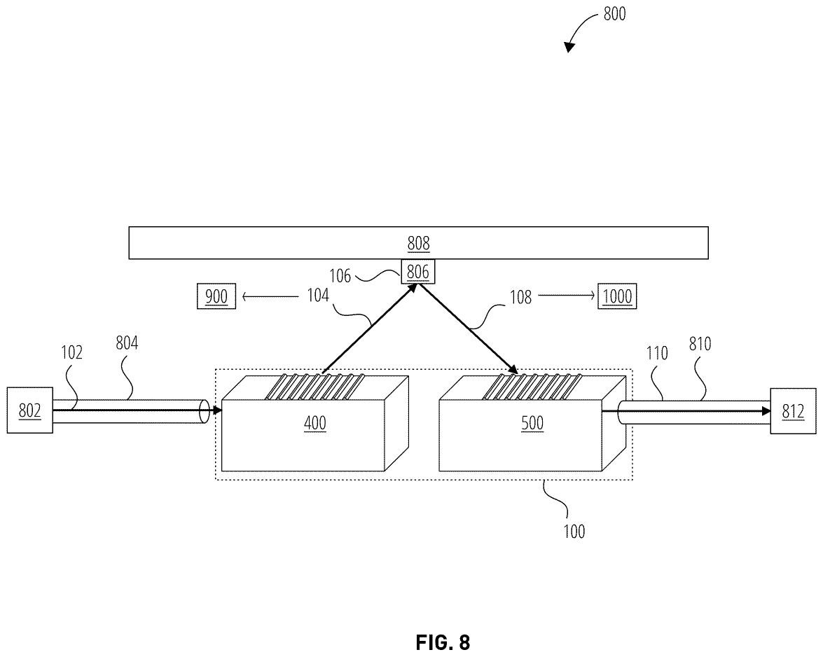

The emitted beam 104 may reflect from the reflection target 106, which in one embodiment may be a point on a planar surface that is parallel to and 1 mm away from the surfaces of the input coupling 400 and output coupling 500 as shown. In one embodiment, the reflection target 106 may be an alignment feature on a silicon wafer under manufacture, as illustrated in FIG. 8. The reflection target 106 may reflect the emitted beam 104 such that the reflected beam 108 is a collimated beam of broadband electromagnetic signals.

The reflected beam 108 may project onto the output grating structure 504 of the output coupling 500. The output waveguide layer 502 of the output coupling 500 may guide the resulting output signal 110 along the length of the output coupling 500 through waveguide transmission with a transmission efficiency >0.3. The output signal 110 may be light waveforms having defined discrete wavelengths in the 500 nm to 900 nm band. The output signal 110 may be emitted at an edge of the output coupling 500 into, for example, a coupled fiber with low loss for each discrete wavelength.

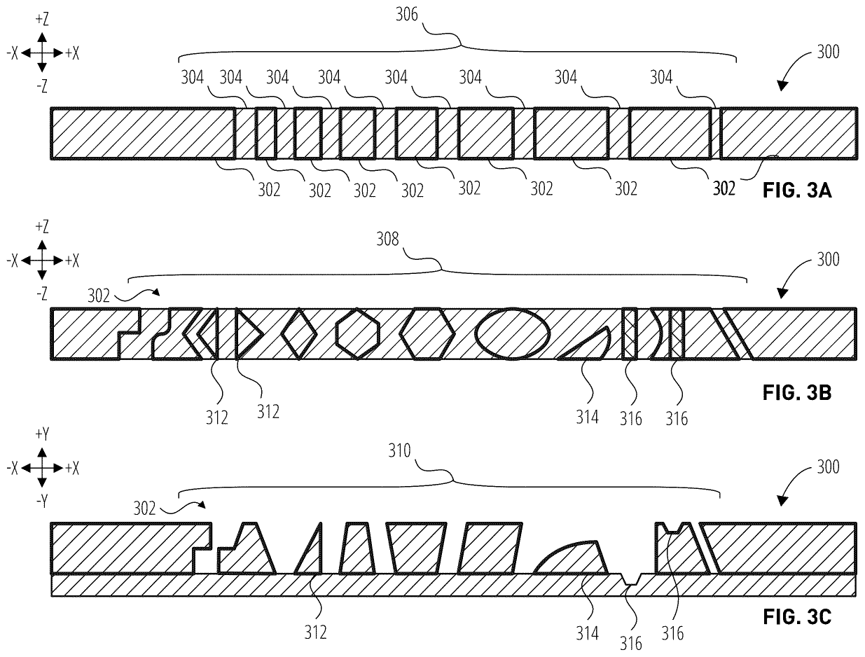

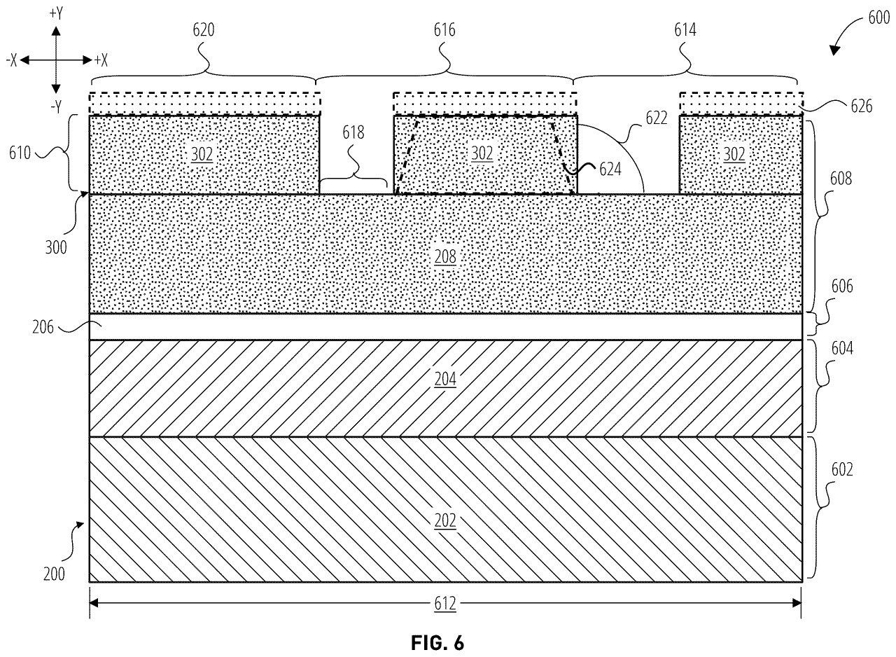

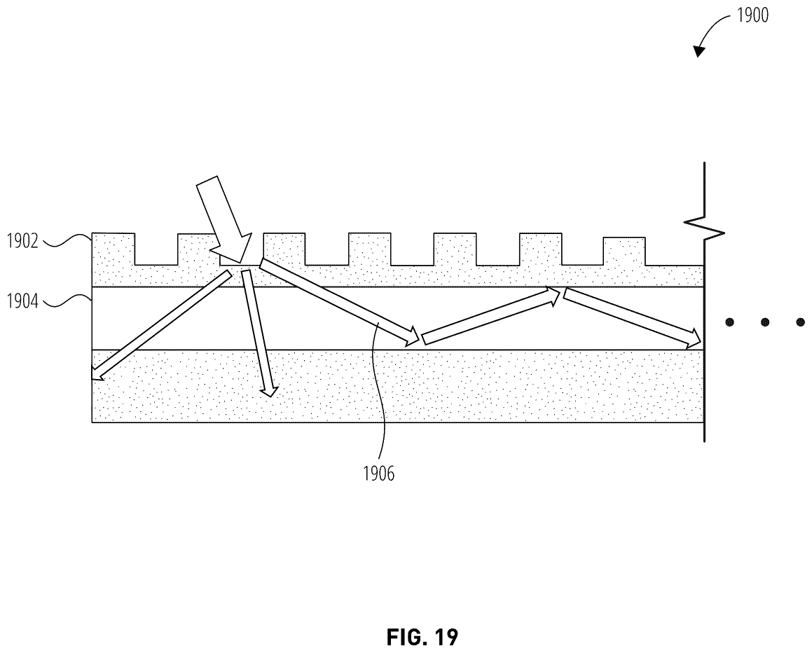

In one embodiment, the broadband grating coupler 100 may take advantage of guided-mode resonance (described in greater detail with respect to FIG. 19 through FIG. 21) using normal gratings. In one embodiment, the gratings may be apodized. Gratings may be shaped in some embodiments. For example, the grating area may have top view profiles that are triangles, sectors, inverse design patterns, etc. in various embodiments, as shown in FIG. 3C. The broadband grating coupler 100 may incorporate double grating layers, as shown in FIG. 6.

FIG. 2 illustrates an apodized grating coupler 200 in accordance with one embodiment. The semiconductor apodized grating coupler 200 may be defined as a structure that is faceted with multiple surfaces between various layers.

With reference to FIG. 2 and in agreement with embodiments of the disclosure, a semiconductor apodized grating coupler 200 may include a semiconductor substrate layer 202 wherein other deposition may take place. The term “substrate” or “semiconductor substrate layer” may include all semiconductor material and all forms of such material. In one embodiment, silicon may be chosen to be the substrate layer.

The layer above the substrate layer 202 surface may be a buffer or buried insulator layer 204. The buried insulator layer 204 may comprise insulating material, e.g., silicon dioxide, silicon nitride, etc. Another buffer layer may be chosen depending on the application.

The other surfaces may be formed by various deposition techniques on silicon-on-insulator (SOI) substrates. The metal reflector layer 206 may be arranged in a layer stack on top of the insulator layer 204. Gold may be used for the reflector layer 206 in one embodiment. Other metals may also be chosen depending on the particular application. A waveguide layer 208 may comprise a semiconductor material such as silicon nitride which is deposited on the top of the reflector layer 206. An apodized grating structure 300 atop the waveguide layer 208 may comprise a plurality of grating elements 302.

FIG. 3A through FIG. 3C illustrate apodized grating structures 300 in accordance with one embodiment. FIG. 3A and FIG. 3B show top views and FIG. 3C shows a side view. “Apodized grating” refers to the grating of a grating coupler for which the geometric parameters for the grating, such as periodicity and etch length, vary across the grating. The drawings also include reference directions (X, Y and Z) to the top left of each figure. FIG. 3A and FIG. 3B may also represent the top view of the apodized grating coupler 200 previously introduced, where the grating elements 302 of the apodized grating structure 300 are visible. FIG. 3C may illustrate a side view of the uppermost portion of the apodized grating coupler 200.

The apodized grating structure 300 may comprise a number of grating elements 302 separated by pitches or spacings 304. The grating elements 302 and their pitches or spacings 304 may form a grating pattern 306. As shown in FIG. 3A, when viewed from the top (i.e., when viewing the top view pattern), the grating elements 302 may be of a substantially similar-shaped (i.e., rectangular-shaped) configuration, may have varying lengths and pitches or spacings 304 in the X-direction, to form the apodized grating structure 300. The grating elements 302 may have the same widths in the Z-direction, as illustrated in FIG. 3A.

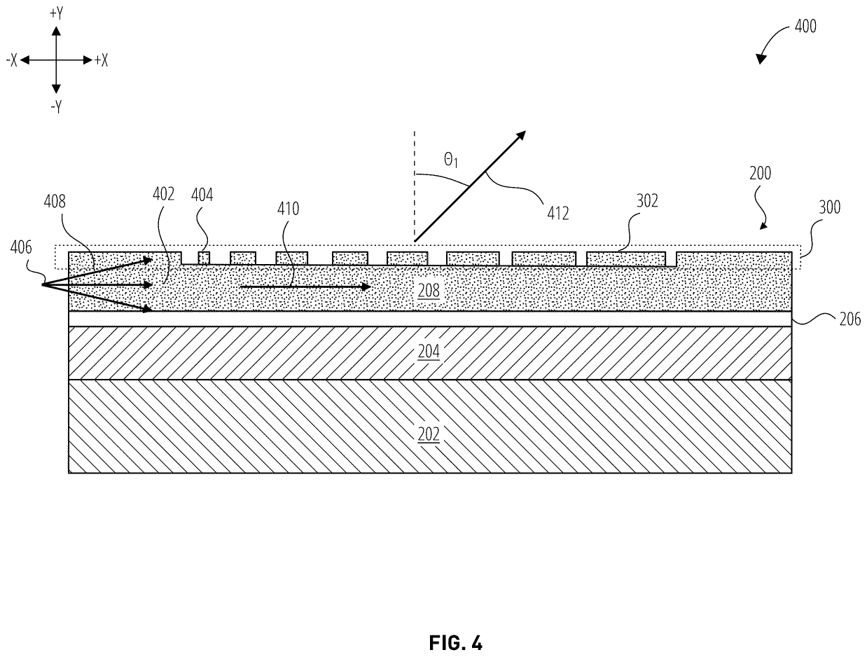

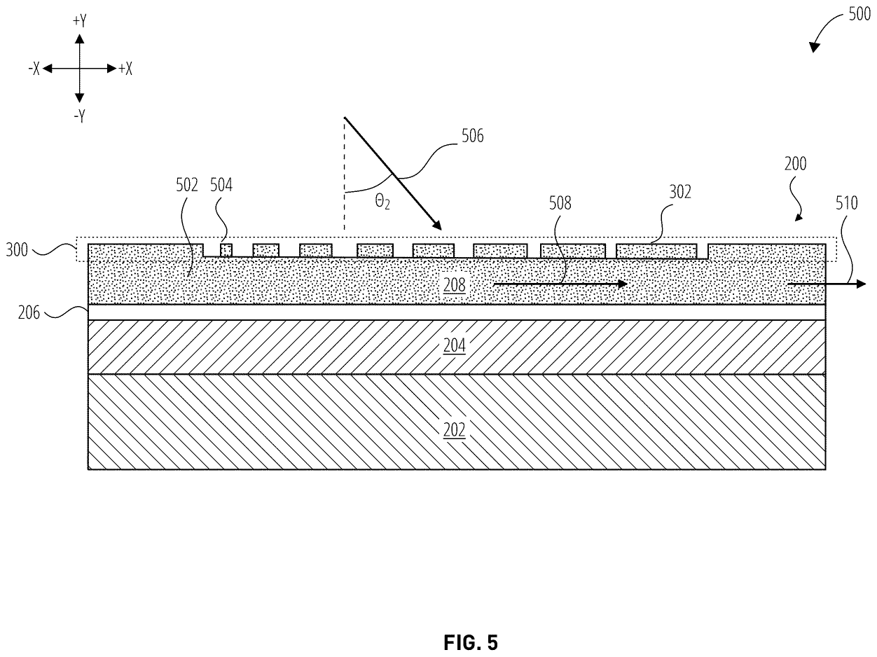

The disclosed apodized grating structure 300 design may couple in multiple wavelengths within a range of 500 nm to 900 nm to a waveguide layer 208 of an apodized grating coupler 200 with a coupling efficiency of nearly 40% when using a broadband source of that range in illuminating the apodized grating structure 300 of the apodized grating coupler 200, as shown by broadband signal source 506 in FIG. 5. With the same design, if light is edge coupled, as shown by the broadband signal source 406 of FIG. 4, then a broadband collimated beam (500 nm to 900 nm) may be emitted at a particular angle θ₁ with coupling efficiency greater than 30%, as shown by diffracted light 412.

These grating element 302 characteristics of shape, length, pitch, and width may be varied as appropriate to the desired performance parameters, such as transmission angle, wavelength(s), and efficiency. Such variations may be created through one or more stages of deposition, etching, and other techniques, as are well known to one of ordinary skill in the art.

The grating elements 302 may also and/or alternatively be of shapes other than rectangular when seen from the top, as shown in FIG. 3B, or the side, as shown in FIG. 3C. Top view patterns 308 of apodized grating structures 300 may be configured with triangular patterns, sector patterns, and inverse design patterns through the fabrication of triangular pattern elements 312, sector pattern elements 314, and inverse design pattern elements 316, or elements forming a pattern design that is inverted (i.e., etched into the tops of grating elements 302 and/or into the pitches or spacings 304 between grating elements 302).

Grating elements 302 and the regions between them may be angled, triangular, rhomboid, polygonal, ellipsoid, or stepped, may have right, obtuse, or acute angles, and may implement rectilinear or curvilinear lines, planes, and shapes to form top view patterns 308 and/or side-view patterns 310 other than that indicated for the apodized grating structure 300 of FIG. 3A and used elsewhere herein. The facing edges of adjacent grating elements 302 may be parallel or non-parallel in whole or part. Apodization may involve such variations grating element 302 shape, as well as the length along the X-axis, width along the Z-axis, and depth along the Y-axis of the grating elements 302 and pitches or spacings 304 between them. In this manner, the apodization may be tuned or otherwise configured in various ways to achieve the desired performance parameters described above.

FIG. 4 illustrates the apodized grating coupler 200 of FIG. 2 used as the input coupling 400 introduced in FIG. 1, in accordance with one embodiment. The input coupling 400 may include an input waveguide layer 402 and an input grating structure 404 in close proximity to the input waveguide layer 402. The input grating structure 404 may be an apodized grating structure 300 having grating elements 302.

A Gaussian broadband or other broadband signal source 406 may act as the input signal 102 introduced in FIG. 1. The projection of the broadband signal source 406 within a range of angles 408 may result in coupling within the input waveguide layer 402 as is well known to individuals skilled in the art. The light so received from the broadband signal source 406 may then travel as propagated light 410 within the input waveguide layer 402. The light may then diffract out through the grating elements 302 of the input grating structure 404, and may form the emitted beam 104 of FIG. 1. This diffracted light 412 may be collimated at a particular angle θ₁. The particular angle at which the broadband diffracted light may be collimated may be determined through a far-field estimation technique.

The outcoupling angle θ₁ of the input coupling 400 may be governed by the grating equation, which also illustrates the phase-matching condition between the propagated light 410 traveling in waveguide mode and the diffracted light 412 traveling in radiation mode. By combining spatial fluctuation of the refractive index with various periodicities (illustrated in FIG. 6) the distribution of the electric field in the waveguide mode (the propagated light 410) may be represented as the summation of all the harmonics present in it. Thus, the phase matching condition may be fulfilled between the field in waveguide mode (propagated light 410) and the field of all other radiation modes (diffracted light 412). It may also be implied that energy in the waveguide mode may couple into distinct radiation modes satisfying the grating diffraction equation. So, all of these waves may respond to the refractive index tuning.

Even so, the grating equation states that etch depth (illustrated in FIG. 6) and the number of periods may not have a substantial effect on the effective index and therefore may not have much influence upon the out-coupling angle θ₁. In addition, the electric field close to the grating region may have an extended decaying tail for a shallow etch depth. As a result, the outcoupling beam width of the diffracted light 412 may be wider when the beam comprises broadband (500 nm to 900 nm) light waveforms.

FIG. 5 illustrates the apodized grating coupler 200 of FIG. 2 used as an output coupling 500 in accordance with one embodiment. The output coupling 500 may include an output waveguide layer 502 and an output grating structure 504 in close proximity to the output waveguide layer 502. The output grating structure 504 may be an apodized grating structure 300 having grating elements 302.

A Gaussian broadband or other broadband signal source 506 may be projected at a specific angle θ₂ onto the output grating structure 504 which comprises a plurality of grating elements 302. This may be considered analogous to the reflected beam 108 of FIG. 1. The light from this broadband signal source 506 may be coupled by the output waveguide layer 502, and may travel as propagated light 508 within the output waveguide layer 502. At the edge of the output waveguide layer 502, this light may exit as emitted light 510, essentially forming the output signal 110 of FIG. 1. The projection angle θ₂ of the broadband signal source 506 may be selected to achieve a maximum coupling of desired wavelengths inside the output waveguide layer 502 as is well known to individuals skilled in the art.

The coupling of multiple wavelengths which may be detected where the emitted lights 510 exits the output waveguide layer 502 may be well interpreted by the guided-mode resonance (GMR) analogy, wherein the apodized output grating structure 504 and rectangular output waveguide layer 502 may be brought together where the projection angle θ₁ of the broadband signal source 406 of the diffracted mode matches with the angle of propagated light 410 in guided mode or waveguide mode. In the GMR analogy at resonance, a portion of the applied field is coupled into a guided mode. The guided mode then gradually leaks out from the waveguide. The leaked field interferes with the applied field generating a filtering response. With source angle variation θ₂ one may observe different wavelengths getting filtered at a particular incident source angle θ₂. At −35 degrees, two resonance peaks may be observed. If the source angle θ₂ is changed to −14 degrees, multiple peaks at different wavelengths may be detected. Two resonances may be thought of as multiple resonances overlapping, where changes in the projection angle may destroy the symmetry of the problem, causing those resonances to diverge. The resonance peaks may traverse toward and away from overlap depending on angle θ₂.

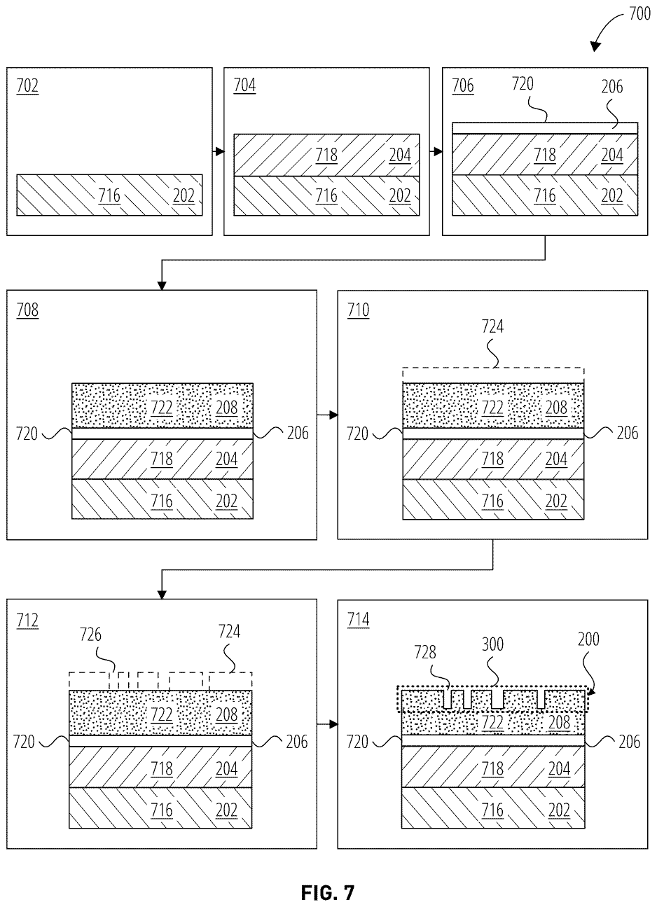

FIG. 6 illustrates parameters of an apodized grating structure 600 in accordance with one embodiment. These parameters may be determined by material deposition, etching, and other processes performed during the grating fabrication stages 700 illustrated in FIG. 7.

Thicknesses of the various layers are indicated in the Y-direction, including the substrate layer 202 thickness 602, the insulator layer 204 thickness 604, the reflector layer 206 thickness 606, the waveguide layer 208 thickness 608, and the grating depth 610, which is the depth to which the waveguide layer 208 may be etched to form the grating elements 302 of the apodized grating structure 300. Thicknesses 602-610 are tunable and may be independently selected.

The grating depth 610 may influence the performance of the apodized grating coupler 200 through its impact on the effective index of refraction of the apodized grating structure 300. As grating depth 610 increases, the effective index of refraction of the shallow etched area decreases, thus decreasing the effective index. Shallow etching and full etching of the waveguide layer 208 may be responsible for the diffraction angle and collimation of diffracted light emitted by the waveguide. The above elaboration is well known to those skilled in the art.

The apodized grating structure 300 of the apodized grating coupler 200 may have varying grating periods along its length 612, exemplified by the grating period 614 and grating period 616 illustrated. These grating periods may vary along the length 612 of the waveguide, in conformance with one of the characteristics of an apodized grating. These grating period variations may include variations in the grating element pitch 618 between grating elements 302, as well as variations in the grating element length 620 of each grating element 302. The selected grating periods may be the parameters with the most impact on the grating wavelength. The coupling of multiple wavelengths within the apodized grating coupler 200 may be clearly understood as a function of the varying grating periods and the resulting change in the effective refractive index, as will be readily understood by those skilled in the art.

FIG. 6 also depicts an etching angle 622 at which the grating elements 302 may be etched into the waveguide layer 208 to form the apodized grating structure 300 of the apodized grating coupler 200. In the illustration, the etching angle 622 is shown as a right angle, which may be the best fit when fabrication tolerances are considered. The etching angle 622 or “tooth angle” may be tunable. An obtuse angle 624 may be selected for the etching angle 622 on one or both sides of one or more grating elements 302 to achieve maximum coupling efficiencies of the coupled wavelength or for improved light-matter interaction.

In one embodiment, the apodized grating structure 300 may be a bilayer grating. An upper grating layer 626 of a material different from the waveguide layer 208 may be deposited during manufacture and etched concurrently with or subsequent to the etching of the waveguide layer 208 (which is described in greater detail below). The period and tooth angle of the upper grating layer 626 may be varied as previously described for the apodized grating structure 300 for the purposes of tuning and improving the efficiency of the grating for transmissions of various wavelengths and diffraction angles.

FIG. 7 illustrates grating fabrication stages 700 in accordance with one embodiment. An apodized grating coupler 200 is shown in cross-section throughout the various grating fabrication stages 700 using various processing techniques. In this manner, various semiconductor and non-semiconductor material layers may be stacked during subsequent stages to form an apodized grating coupler 200, as described below. Note that the thicknesses of the layers developed may not appear to scale.

Stage 702 may begin with forming a substrate layer 202. Stage 702 may include piranha cleaning of a silicon sample. In this illustrative process flow the cleaned sample may form a silicon substrate layer 716. The silicon substrate layer 716 may have a thickness 602 of 500 microns.

Stage 704 may include the deposition of an insulator layer 204, which may be a silicon dioxide insulator layer 718 or “buffer layer”. The silicon dioxide insulator layer 718 may have a thickness 604 of 2-3 microns. The silicon dioxide insulator layer 718 may be vertically deposited above the silicon substrate layer 716 through plasma-enhanced chemical vapor deposition (PECVD). The thickness of the insulator layer 204 may be tunable depending on the application. This thickness 604 may be chosen equivalently with the working wavelength intended for the apodized grating coupler 200.

After deposition of the silicon dioxide insulator layer 718, stage 706 may include forming a reflector layer 206. For example, this may involve the deposition of gold in a metal reflector layer 720 that may have a thickness 606 of 100-200 nm. This may be carried out by the sputtering method. Gold or another metal or other material may be chosen for the metal reflector layer 720 to reflect leaked light back into the silicon nitride waveguide layer 722 and grating elements 302. In various embodiments, the metal reflector layer 720 may include gold, aluminum, and iron or other ferrous materials.

After stacking the metal reflector layer 720 above the silicon dioxide insulator layer 718, stage 708 may include forming a waveguide layer 208. This may be performed through the deposition of silicon nitride to form a silicon nitride waveguide layer 722 having a thickness 608 of around 1.5 microns in one embodiment. Low-pressure chemical vapor deposition (LPCVD) may be used so that the stoichiometry of the silicon nitride does not change.

Following the deposition of the silicon nitride waveguide layer 722, stage 710 may include applying a coating of negative photoresist 724. Negative photoresist 724 may be spin-coated above the silicon nitride waveguide layer 722.

Stage 712 may include patterning the spin-coated negative photoresist 724 using E-beam lithography. The negative photoresist 724 may be developed and selectively etched. After development, the negative photoresist 724 may exhibit the developed pattern 726 as shown. Following the patterning process, etching to a desired depth (shallow etch) may be carried out using reactive ion etching (RIE).

Stage 714 may include the development and selective etching of the grating pattern 728. The grating pattern 728 may be etched into the silicon nitride of the silicon nitride waveguide layer 722 to form the desired apodized grating structure 300 upon the apodized grating coupler 200.

In one embodiment, additional materials and processes may be used to apply an additional upper grating layer 626 onto the apodized grating structure 300 as previously described. According to the present disclosure represented in FIG. 7, all of these fabrication steps may be readily apparent to a person skilled in the art.

FIG. 8 illustrates a broadband grating coupler illuminating wafer alignment marks 800 in accordance with one embodiment. A broadband signal source 802 may generate an input signal 102 that may be carried through an input optical fiber 804 to an interface with an input coupling 400. The input signal 102 may comprise wavelengths from 500 nm to 900 nm.

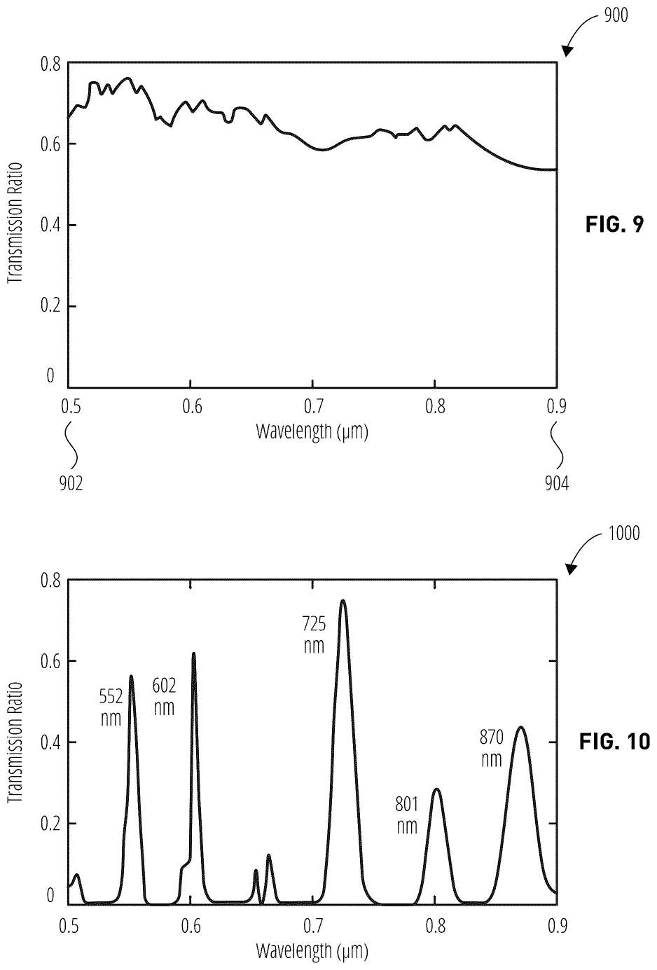

The input signal 102 may be diffracted by the input coupling 400 as a collimated emitted beam 104, illuminating and incident upon a reflection target 106 such as the alignment feature 806 of the silicon wafer 808. The emitted beam 104 may exhibit the broadband input waveform characteristics 900 shown in FIG. 9. The electromagnetic signal may be reflected from the alignment feature 806 as a collimated reflected beam 108 and may be incident upon the output coupling 500. The reflected beam 108 may be of a higher order diffracted wavelength and may have the discrete wavelength output waveform characteristics 1000 shown in FIG. 10.

The reflected beam 108 may be coupled within and travel through a waveguide layer of the output coupling 500 as an output signal 110. The output signal 110 may be emitted onto an output optical fiber 810, through which it may be transmitted and detected as a detected discrete wavelength output 812 from the broadband grating coupler illuminating wafer alignment marks 800.

The input coupling 400 and output coupling 500 may be apodized grating couplers 200 such as those illustrated in FIG. 2 through FIG. 6 and may be fabricated using the grating fabrication stages 700 illustrated in FIG. 7. The input coupling 400 may be of a different design from the output coupling 500. In another embodiment, the input coupling 400 and output coupling 500 may be of the same design.

FIG. 9 illustrates broadband input waveform characteristics 900 of an emitted beam 104 in accordance with one embodiment. In one embodiment, the broadband input waveform characteristics 900 may include a minimum wavelength 902 of 500 nm (0.5 μm) and a maximum wavelength 904 of 900 nm (0.9 μm) as illustrated.

FIG. 10 illustrates discrete wavelength output waveform characteristics 1000 of a reflected beam 108 in accordance with one embodiment.

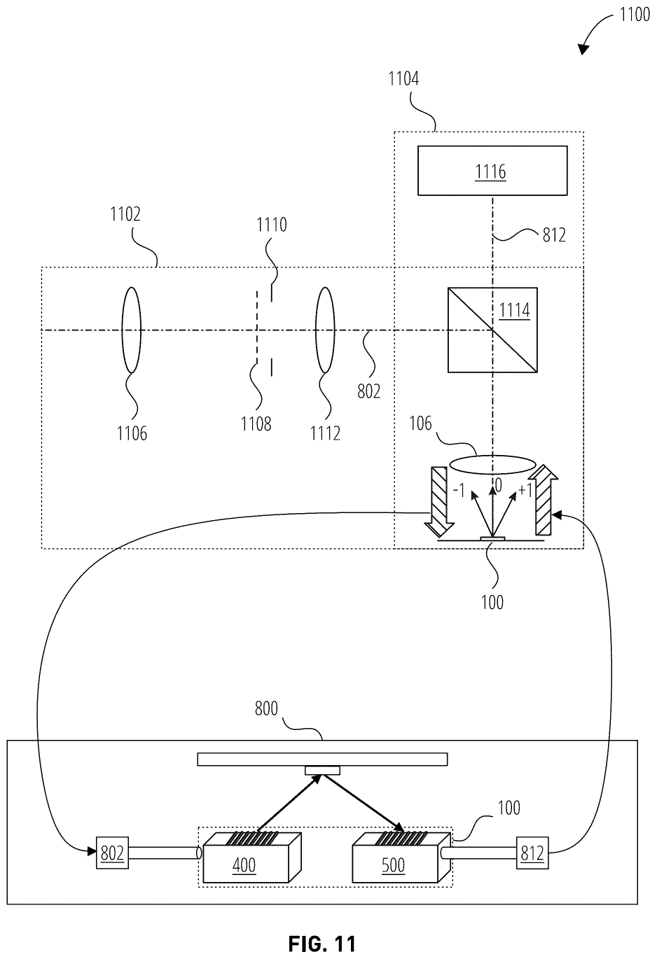

FIG. 11 illustrates a wafer alignment system 1100 in accordance with one embodiment. The wafer alignment system 1100 may use the broadband grating coupler 100 of FIG. 1 as a broadband grating coupler illuminating wafer alignment marks 800, such as that illustrated in FIG. 8.

The illumination part 1102 of the wafer alignment system 1100 may in one embodiment incorporate a lens 1106 providing illumination pupil correction. The lens 1106 may focus the illumination at a corrected pupil plane 1108. The illumination may pass through a stop 1110 to a second lens 1112 which focuses the resulting uniform broadband signal source 802 onto a prism 1114 that directs that waveform onto a mark grating, such as the input coupling 400 of the broadband grating coupler 100. The broadband signal source 802 may be directed through the input optical fiber 804 and input coupling 400, onto the reflection target 106, and thence to the output coupling 500 and output optical fiber 810 as previously described to generate a detected discrete wavelength output 812.

The detected discrete wavelength output 812 of the broadband grating coupler illuminating wafer alignment marks 800 may be collected by the imaging unit 1104 for analysis. In one embodiment, the detected discrete wavelength output 812 may be directed by the prism 1114 onto a Mach Zehnder interferometer 1116, which is a device used to detect relative phase shift variations between two collimated beams. This phase shift detected by the imaging unit 1104 of the wafer alignment system 1100 may be used to determine whether or not the wafer is in alignment and may begin its next processing step. The wafer alignment system 1100 using the broadband grating coupler illuminating wafer alignment marks 800 may be able to detect alignment issues based on stresses upon the wafer more accurately, and with an apparatus taking up less space, than is conventionally possible.

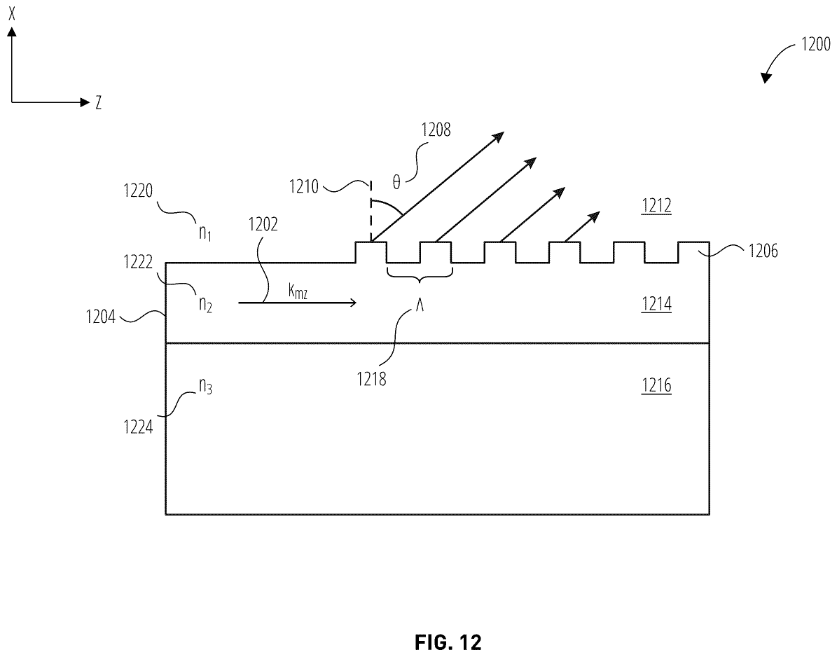

FIG. 12 illustrates a conventional grating 1200. The conventional grating 1200 may be a broadband grating having a bandwidth above −3 dB of up to 100 nm with a center wavelength of 1550 nm. Components of an electromagnetic waveform 1202, such as a broadband light signal, may propagate in a waveguide layer 1204 along the Z-axis, as represented by k_{mz}. The electromagnetic waveform 1202 may diffract out of a grating structure 1206 of the conventional grating 1200 at a diffraction angle 1208 (θ) measured with respect to grating normal 1210, as shown.

The material above the waveguide layer 1204 and grating structure 1206 may be a first transmission medium 1212 having a first refractive index 1220 of n₁. The waveguide layer 1204 and grating structure 1206 may be of a second transmission medium 1214 having a second refractive index 1222 of n₂. The material below the waveguide layer may be a third transmission medium 1216 having a third refractive index 1224 of n₃.

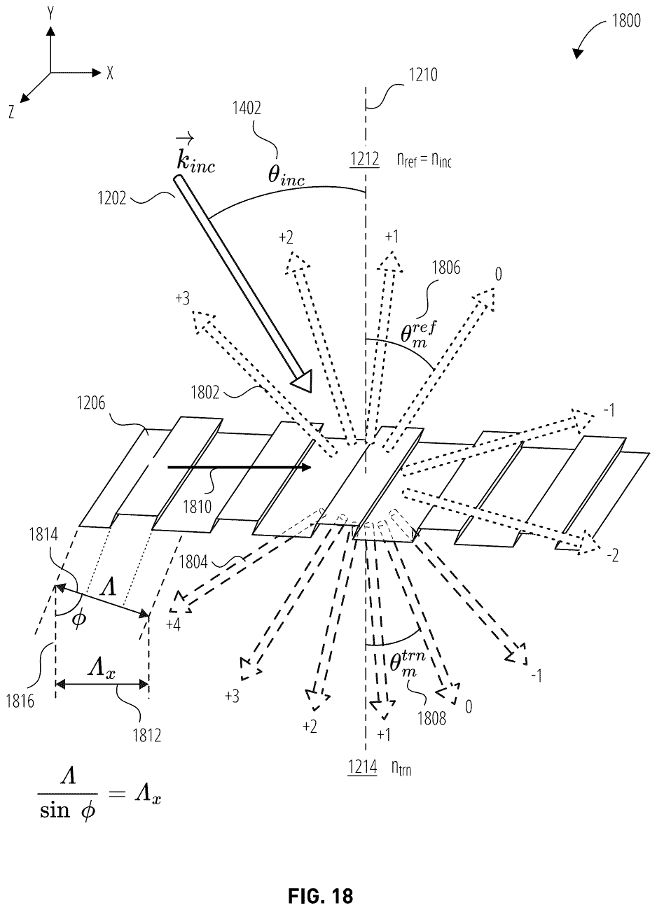

The “m” of k_{mz} may stand for an integer number representing an order of diffraction for the waveform. Orders of diffraction are the number of times a wave, like sound or light, bends or spreads out as it passes through an obstacle or narrow opening, such as the grating elements of the conventional grating 1200. The orders of diffraction depend upon the wavelength of the electromagnetic wave and the dimensions and characteristics of the grating elements. Each order corresponds to a specific diffraction angle (θ), and higher orders result in smaller angles. Orders of diffraction are further illustrated by and described with respect to FIG. 18.

A relationship may be written between the diffraction angle 1208 (θ) and the grating period 1218 (∧) of the grating structure 1206. Equations expressing this relationship are provided below with respect to the following illustrations.

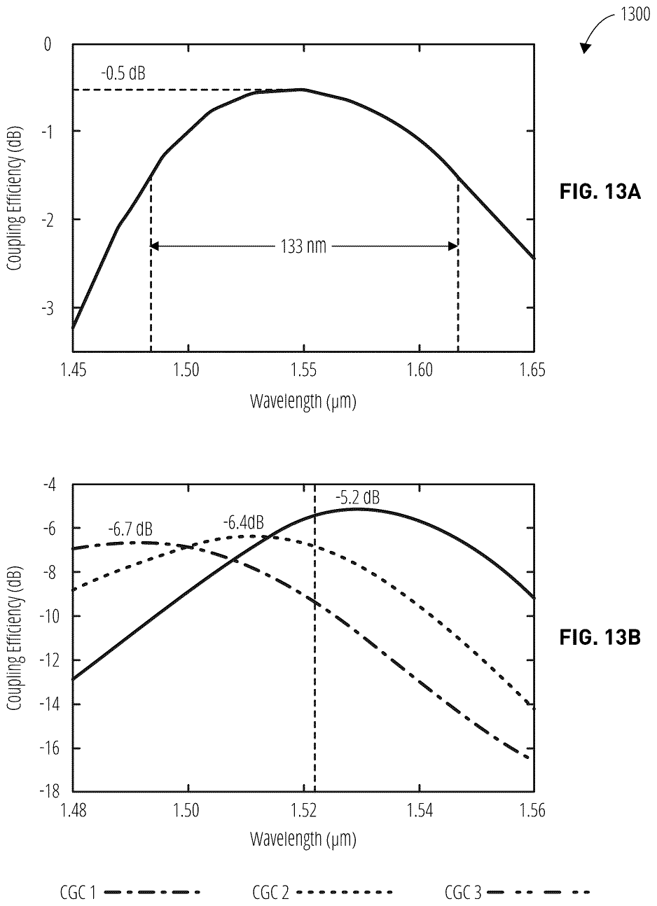

FIG. 13A and FIG. 13B illustrate conventional grating coupling efficiency-bandwidth responses 1300. FIG. 13A shows the response of a conventional zero-order grating coupler having a bandwidth of 133 nm above −1.5 dB around a center wavelength of 1550 nm (1.55 μm). FIG. 13B shows responses for three additional conventional grating couplers (CGCs).

The measured coupling efficiency (CE) of conventional grating couplers is shown and may be used as a calibration function of the wavelength of the transmitted signal. The 1-dB bandwidth of conventional grating couplers, such as may be constructed using the conventional grating 1200 of FIG. 12, may be on the order of 30 nm. The dashed line of FIG. 13B shows the center wavelength of the spectral response that is measured using conventional grating couplers as input interfaces.

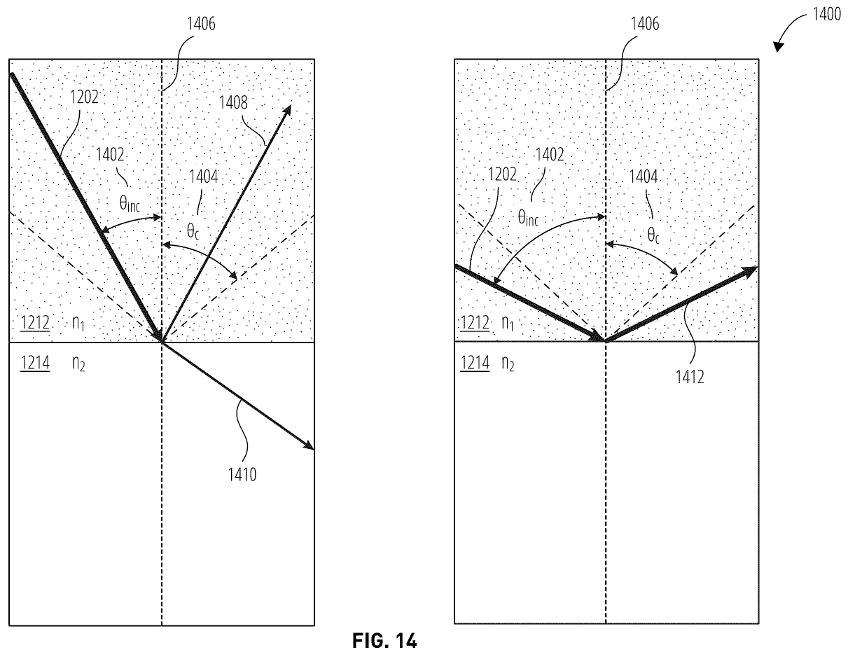

FIG. 14 illustrates the critical angle and total internal reflection 1400. An electromagnetic waveform 1202 is shown traveling through a first transmission medium 1212 of refractive index n₁ and incident upon a second transmission medium 1214 of refractive index n₂ in two cases: first where the angle of incidence 1402 (θ_{inc}) is less than the critical angle 1404 (θ_{c}) and second where the angle of incidence 1402 is greater than the critical angle 1404. Both angles are measured from a line normal 1406 to the plane of intersection of the two media running through the point at which the electromagnetic waveform 1202 is incident upon that plane.

When such an electromagnetic waveform 1202 travels through a first transmission medium 1212 and is incident on a second transmission medium 1214 with a lower refractive index (i.e., n₂<n₁) if the angle of incidence 1402 is less than the critical angle 1404, the electromagnetic waveform 1202 may be partially reflected and partially refracted, as indicated by the partially reflected waveform 1408 and partially refracted waveform 1410 shown.

When the electromagnetic waveform 1202 travels through the same first transmission medium 1212 and is incident upon the second transmission medium 1214 at an angle of incidence 1402 that is greater than the critical angle 1404, that wave may be completely reflected, as shown by the totally reflected waveform 1412.

The critical angle 1404 depends on the refractive indices, as follows:

$${θ}_{c} = {sin}^{- 1} ( \frac{{n}_{2}}{{n}_{1}} ) \qquad Eq . 1$$

For example, the following calculation may be performed to obtain the critical angle for fused silica (glass) (optical waveguide glass having n₁=1.5) at a boundary with a vacuum (n₂=1).

$${θ}_{c} = {sin}^{- 1} ( \frac{1}{1.5} ) = 41.81 ° . \qquad Eq . 2$$

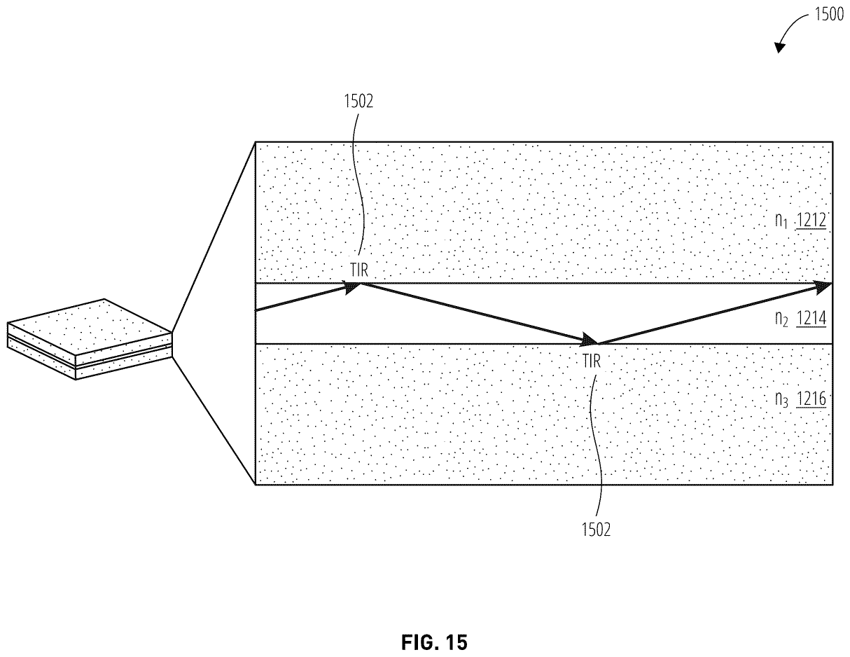

FIG. 15 illustrates a slab waveguide 1500. When a slab of a second transmission medium 1214 material is placed between a first transmission medium 1212 and a third transmission medium 1216, both having lower refractive indices (i.e., n₂<n₁ and n₂<n₃), total internal reflection 1502 (TIR) may be achieved and a slab waveguide 1500 is created.

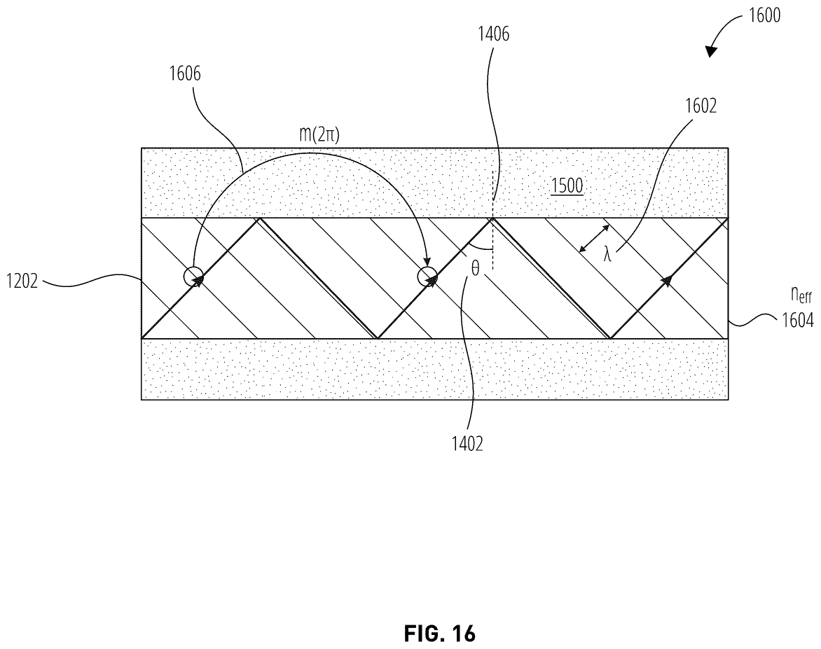

FIG. 16 illustrates a ray tracing analysis 1600. An electromagnetic waveform 1202 may be traveling through a waveguide layer 1604 of a slab waveguide 1500 and may be coupled within the waveguide layer 1604. The waveguide layer 1604 may, in conducting the electromagnetic waveform 1202, exhibit an effective refractive index (n_{eff}). The effective refractive index may depend on the propagation constant of the material of the waveguide layer 1604 and may be related to the wavelength of the electromagnetic waveform 1202 and the angle of incidence 1402 at which it reflects within the waveguide layer 1604. These relationships are described by the following equation.

$$β = {k}_{0} {n}_{eff} = \frac{2 π}{λ} n sin ( θ ) \qquad Eq . 3$$

where:
β is the propagation constant,
k₀ is the wave number or the magnitude of the wave in a vacuum,
λ is the wavelength 1602 of the wave,
n is the absolute refractive index of the waveguide layer 1604 material, and
θ is the angle of incidence 1402 of the electromagnetic waveform 1202 at the top and bottom boundaries of the waveguide layer 1604.

The roundtrip phase 1606 of a ray will be an integer (m) multiple of 2π. Only certain angles are allowed to propagate in the waveguide.

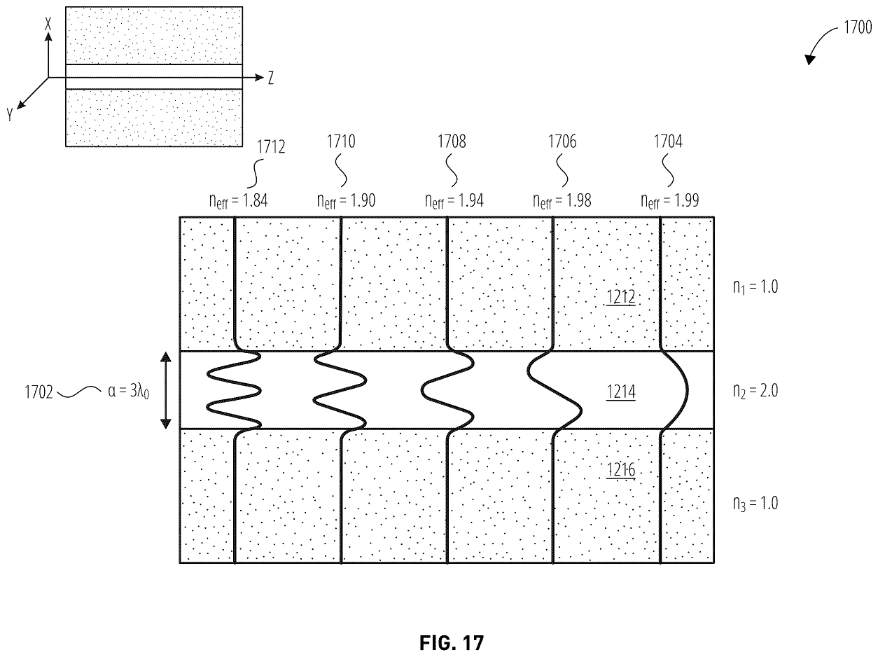

FIG. 17 illustrates a slab waveguide analysis using Maxwell's equations 1700. A rigorous analysis of slab waveguides may be performed using these equations, shown as Eq. 4 and Eq. 5 below.

$$∇ \times E = - j ω μ H \qquad Eq . 4$$

$$∇ \times H = j ω μ E \qquad Eq . 5$$

Putting these equations for a slab waveguide 1500, such as was previously introduced, in matrix form may yield an Eigenvector matrix representing the guided modes possible for the waveguide. These calculations will be readily understood by one of ordinary skill in the art.

The geometry and corresponding mode solutions for a conventional slab waveguide are illustrated in FIG. 17. The first-order mode 1704, second-order mode 1706, third-order mode 1708, fourth-order mode 1710, and fifth-order mode 1712 are illustrated for a first transmission medium 1212 having a refractive index of 1.0, a second transmission medium 1214 having a refractive index of 2.0, and a third transmission medium 1216 having a refractive index of 1.0. The second transmission medium 1214 may be of a thickness 1702 (α) along the X-axis that is three times the wavelength of the electromagnetic waveform 1202 in a vacuum (λ₀), as shown.

FIG. 18 illustrates diffraction from gratings 1800. In this figure, \vec{k}_{inc} is the vector representing the electromagnetic waveform 1202 (i.e., the light) that is incident upon the grating structure 1206, illustrated using a solid vector arrow. The electromagnetic waveform 1202 may be reflected, as shown by the reflected waveforms 1802 illustrated using dotted vector arrows, and transmitted and the transmitted waveforms 1804, which are shown using dashed vector arrows on either side of the grating structure 1206.

The grating structure 1206 may form a boundary between a first transmission medium 1212 and a second transmission medium 1214. The first transmission medium 1212, in which both the incident and reflected waveform are transmitted, may have a refractive index of the reflection region (n_{ref}) and a refractive index of the incident region (n_{inc}), which are equal, as shown. The second transmission medium 1214 may have a refractive index for a transmission region (nₜᵣₙ).

In one embodiment, the grating structure 1206 may be slanted across the X-Y plane, as shown. The vector component of the electromagnetic waveform 1202 that is tangential to the grating structure 1206, shown as tangential waveform component 1810, may be continuous across the interface of the grating structure 1206 and may thus satisfy boundary conditions of the grating equation. The grating period along the X-axis (∧ₓ) may be related to the period of the grating along its slant as follows:

$${Λ}_{x} = \frac{Λ}{sin ϕ} \qquad Eq . 6$$

where φ is the angle between a tangent line in the X-direction and a line normal to the slant of the grating structure 1206. As is well known in the art, component wavelengths of the tangential waveform component 1810 may be matched in phase, and other components may not be, and thus may interfere with each other destructively, and may not need to be considered with regard to transmission and reflection at the grating structure 1206 interface. For these reasons, the grating equation may be developed from the tangential (X-direction) components of the electromagnetic waveform 1202, the reflected waveforms 1802, and transmitted waveforms 1804, as follows:

$${n}_{ref} sin ( {θ}_{m}^{ref} ) = {n}_{inc} sin {θ}_{inc} - m \frac{{λ}_{0}}{Λ} sin ϕ \qquad Eq . 7 - Reflection Region$$

$${n}_{trn} sin ( {θ}_{m}^{trn} ) = {n}_{inc} sin {θ}_{inc} - m \frac{{λ}_{0}}{Λ} sin ϕ \qquad Eq . 8 - Transmission Region$$

where:
n_{ref}, n_{inc}, and nₜᵣₙ are the refractive indices for the regions as described above,
θ_{inc} is the angle of incidence of the electromagnetic waveform 1202 upon the grating structure 1206 measured from grating normal 1210,
θₘ^{ref} is the angle of reflection 1806 of the reflected vector of diffraction order order m,
θₘ^{trn} is the angle of transmission 1808 of the transmitted vector of diffraction order m,
λ₀ is the wavelength of the electromagnetic waveform 1202 in free space,
∧ is the grating period in the direction normal to the slant of the grating structure 1206, and
φ is the angle between a tangent plane normal 1816 of a grating structure tangent plane 1812 (i.e., a line or plane that intersects the grating structure tangent plane 1812 at a right angle) and a grating pattern normal plane 1814 (i.e., a plane normal to the slant of the grating structure 1206). (Note that for gratings with no slant, φ=90 degrees, and sin φ=1.)

The dotted and dashed vector arrows are labeled with integers representing their diffraction orders (m). Reflected waveforms 1802 are shown with vectors for orders 0, ±1, ±2, and +3. transmitted waveform 1804 are shown with vectors for orders 0, ±1, +2, +3, and +4. The angles of the diffracted mode vectors are related to the wavelength and grating through the grating equations Eq. 7 and Eq. 8 above. The grating equation may predict the directions of the modes but not how much power is in them.

FIG. 19 illustrates a guided-mode resonance (GMR) 1900. “Guided-mode resonance” or “waveguide-mode resonance” is a phenomenon wherein the guided modes of an optical waveguide can be excited and simultaneously extracted by the introduction of a phase-matching element, such as a diffraction grating or prism.

When a diffraction grating 1902 and slab waveguide 1904 are brought into proximity, as shown, and the angle of a diffracted mode matches the angle of a guided mode, waveforms 1906 may propagate through the waveguide through guided-mode resonance.

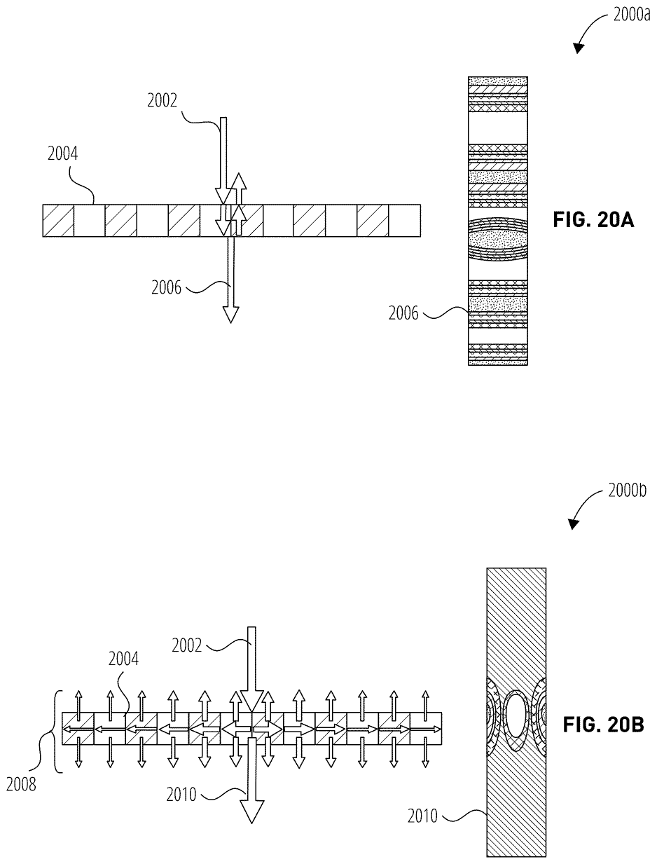

FIG. 20A illustrates a response away from guided-mode resonance 2000a. Away from resonance, broadband input 2002 to a grating structure 2004 may produce a background output response 2006 analogous to the background response of a multilayer device.

FIG. 20B illustrates a response at guided-mode resonance 2000b. At resonance, part of the broadband input 2002 applied wave may be coupled into a guided mode. The guided mode may slowly “leak” out from the waveguide coupled to the grating structure 2004. The leaked wave 2008 may interfere with the applied wave to produce a filtering output response 2010.

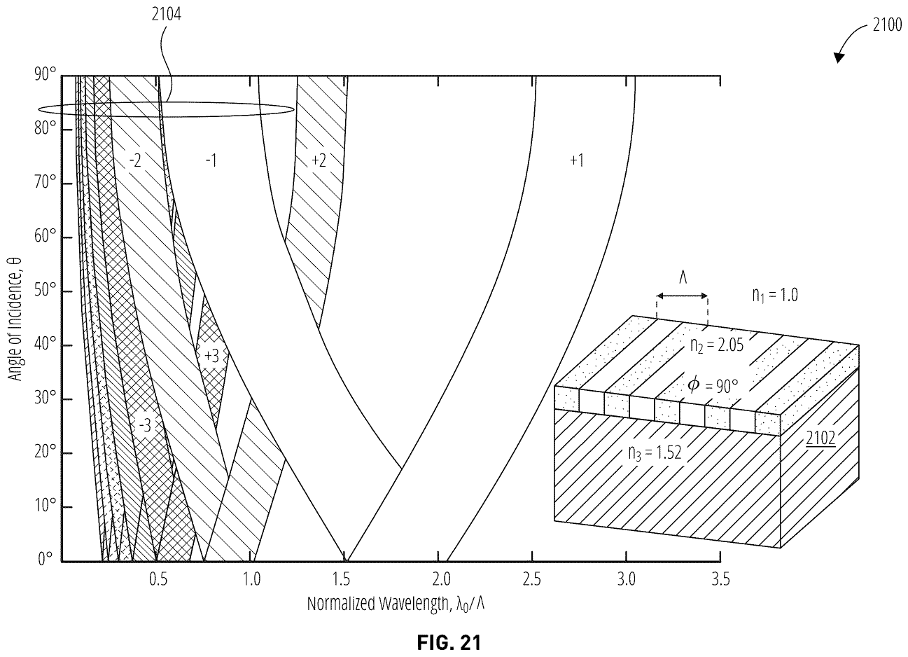

FIG. 21 illustrates regions of guided-mode resonance 2100. The ray tracing equation provided with the description of FIG. 16 and the grating equation provided with respect to FIG. 18 may be used to express and determine an effective refractive index n_{eff} as follows:

$${n}_{eff} = {n}_{1} sin {θ}_{inc} - m \frac{{λ}_{0}}{Λ} sin ϕ \qquad Eq . 9$$

Conditions for n_{eff} to represent a guided-mode resonance may be described as:

$$max [ {n}_{1} , {n}_{3} ] \leq {n}_{eff} < {n}_{2} \qquad Eq . 10$$

Combining the above two equations leads to an equation describing the regions of resonance for guided-mode resonance, as follows:

$$max [ {n}_{1} , {n}_{3} ] \leq \vert {n}_{1} sin {θ}_{inc} - m \frac{{λ}_{0}}{Λ} sin ϕ \vert < {n}_{2} \qquad Eq . 11$$

The figure illustrates, for the experimental structure 2102 shown, plotted regions of guided-mode resonance 2100 using this equation. Ranges for resonant frequencies may be estimated, and sensitivity to angle of incidence may be predicted. Higher order resonances 2104 may be seen to overlap in an area for broadband waveforms having the same angle of incidence. Zero-order modes produce no resonance effects.

The center wavelength at normal incidence may be expressed as:

$$\frac{{λ}_{c}}{Λ} \approx \frac{{n}_{2} + max [ {n}_{1} , {n}_{3} ]}{2 \vert m \vert sin ϕ} \qquad Eq . 12$$

The bounds for a grating exhibiting these characteristics may thus be expressed as:

$$\frac{{λ}_{min}}{Λ} \leq \frac{{λ}_{0}}{Λ} < \frac{{λ}_{max}}{Λ} \qquad Eq . 13$$

$$\frac{{λ}_{min}}{Λ} = \{ \begin{matrix}\frac{{n}_{1} sin {θ}_{inc} - max [ {n}_{1} , {n}_{3} ]}{m sin ϕ} & m < 0 \\ \frac{{n}_{1} sin {θ}_{inc} + max [ {n}_{1} , {n}_{3} ]}{m sin ϕ} & m > 0\end{matrix} \qquad Eq . 14$$

$$\frac{{λ}_{max}}{Λ} = \{ \begin{matrix}\frac{{n}_{1} sin {θ}_{inc} - {n}_{2}}{m sin ϕ} & m < 0 \\ \frac{{n}_{1} sin {θ}_{inc} + {n}_{2}}{m sin ϕ} & m > 0\end{matrix} \qquad Eq . 15$$

where:
λₘᵢₙ is a minimum wavelength of the broadband signal source;
λₘₐₓ is a maximum wavelength of the broadband signal source;
∧ is a grating period of the apodized grating structure;
n₁ is a refractive index of a first transmission medium;
n₂ is the refractive index of a second transmission medium;
n₃ is the refractive index of a third transmission medium;
θ_{inc} is an angle of incidence of the broadband signal source upon the apodized grating structure measured from a grating normal;
φ is the angle between a plane tangent to the grating structure 1206 and a plane normal to the slant of the grating structure 1206, if any (for gratings with no slant, φ=90 degrees, and sin φ=1); and
m is an integer representing an order of diffraction.

The specific embodiments above are for explanatory purposes, as the disclosed solution may be reworked and achieved in a distinct but comparable manner evident to individuals skilled in the art without altering the essence of the disclosure. This disclosure on a broadband grating coupler may hold different applications in various areas such as in alignment sensing, fiber coupling for CWDM, biosensing in which broadband light-matter interaction is used, and in other sensing methods where optical broadband is used.

References herein to words revised by language of estimation such as “about,” “substantially,” etc., are not to be limited to the exact value indicated.

References herein to words revised by language of estimation such as “vertical”, “horizontal,” “above,” etc., are created for instance of examples, and not to restrict, to ascertain a frame of reference. The terms “vertical” and “above” represent the term perpendicular to the “horizontal.”

Numerous embodiments of the current disclosure have been described for illustrative purposes but are not intended to be comprehensive or restricted to the embodiments unveiled. The choice of words employed in this work was selected to best explain the principles of the embodiments provided herein, the real-world application or technical advances over technologies found in the marketplace, and to allow others of ordinary skill in the art to understand the embodiments disclosed herein.

What is claimed is:

1. A broadband grating coupler apparatus comprising:
an input coupling comprising an input waveguide layer, the input coupling configured to receive a broadband signal source;
an input grating structure on the input coupling;
an output coupling comprising an output waveguide layer, the output coupling configured to output discrete wavelengths; and
an output grating structure on the output coupling,
wherein at least one of the input grating structure and the output grating structure is an apodized grating structure, the apodized grating structure comprising a plurality of grating elements whose pitch changes along a length of the at least one input grating structure and output grating structure.

2. The broadband grating coupler apparatus of claim 1, further comprising a reflection target above the surfaces of the input coupling and the output coupling, wherein the input grating structure is configured to diffract the broadband signal source thereby resulting in an emitted beam;
wherein the reflection target is configured to reflect the emitted beam from the input coupling as a reflected beam to the output coupling such that the reflected beam is a collimated beam of broadband electromagnetic signals.

3. The broadband grating coupler apparatus of claim 1, wherein the broadband grating coupler apparatus is configured to operate in regions of guided-mode resonance (GMR), wherein GMR occurs when at least one of:
the input grating structure and the input waveguide layer are in close proximity and a projected angle of a diffracted broadband signal source traveling into the input waveguide layer matches the angle of a propagated light of the broadband signal source traveling in guided mode in the input waveguide layer; and
the output grating structure and the output waveguide layer are in close proximity and projected angle of the diffracted broadband signal source traveling into the output waveguide layer matches the angle of the propagated light of the broadband signal source traveling in guided mode in the output waveguide layer.

4. The broadband grating coupler apparatus of claim 1, wherein the broadband grating coupler apparatus is configured to operate in regions of guided-mode resonance (GMR), wherein GMR occurs when the apodized grating structure exhibits characteristics expressed as:
$$\frac{{λ}_{min}}{Λ} = \{ \begin{matrix}\frac{{n}_{1} sin {θ}_{inc} - max [ {n}_{1} , {n}_{3} ]}{m sin ϕ} & m < 0 \\ \frac{{n}_{1} sin {θ}_{inc} + max [ {n}_{1} , {n}_{3} ]}{m sin ϕ} & m > 0\end{matrix}$$
$$\frac{{λ}_{max}}{Λ} = \{ \begin{matrix}\frac{{n}_{1} sin {θ}_{inc} - {n}_{2}}{m sin ϕ} & m < 0 \\ \frac{{n}_{1} sin {θ}_{inc} + {n}_{2}}{m sin ϕ} & m > 0\end{matrix}$$
wherein:
λₘᵢₙ is a minimum wavelength of the broadband signal source;
λₘₐₓ is a maximum wavelength of the broadband signal source;
∧ is a grating period of the apodized grating structure;
n₁ is a refractive index of a first transmission medium;
n₂ is the refractive index of a second transmission medium;
n₃ is the refractive index of a third transmission medium;
θ_{inc} is an angle of incidence of the broadband signal source upon the apodized grating structure measured from a grating normal;
φ is an angle between a tangent plane normal of a grating structure tangent plane and a grating pattern normal plane; and
m is an integer representing an order of diffraction.

5. The broadband grating coupler apparatus of claim 4, further comprising:
the minimum wavelength of the broadband signal source being 500 nm;
the maximum wavelength of the broadband signal source being 900 nm;
the refractive index of the first transmission medium being 1;
the refractive index of the second transmission medium being equal to the refractive index of the third transmission medium, both being tunable based in part on a design of the apodized grating structure and greater than 1;
the angle of incidence being tunable based in part on the design of the apodized grating structure; and
the grating period being tunable based in part on the design of the apodized grating structure.

6. The broadband grating coupler apparatus of claim 1, wherein at least one of the input coupling and the output coupling comprise:
a silicon substrate layer;
a silicon dioxide insulator layer deposited above the silicon substrate layer;
a metal reflector layer deposited above the silicon dioxide insulator layer;
the input waveguide layer or the output waveguide layer comprising silicon nitride deposited above the metal reflector layer; and
at least one of the input grating structure and the output grating structure including a grating layer created at a top of the input waveguide layer or the output waveguide layer using a spin coating of negative photoresist that is patterned using E-beam lithography, then developed and selectively etched into at least one of the top of the input waveguide layer and the top of the output waveguide layer.

7. The broadband grating coupler apparatus of claim 1, wherein at least one of the input coupling and the output coupling are photonic chips with optical fiber.

8. The broadband grating coupler apparatus of claim 1, wherein at least one of the input coupling and the output coupling comprise:
a substrate layer;
an insulator layer deposited above the substrate layer;
a metal reflector layer deposited above the insulator layer, wherein the metal reflector layer comprises at least one of gold, aluminum, and iron; and
at least one of the input grating structure and the output grating structure including a grating layer created on at least one of a top of the input waveguide layer and a top of the output waveguide layer.

9. The broadband grating coupler apparatus of claim 8, wherein the grating layer is shaped in a top view pattern including at least one of: a triangular pattern, a sector pattern, and an inverse design pattern.

10. The broadband grating coupler apparatus of claim 8, further comprising a double grating layer on at least one of the top of the input waveguide layer and the top of the output waveguide layer.

11. The broadband grating coupler apparatus of claim 10, wherein the grating layer is shaped in a top view pattern including at least one of: a triangular pattern, a sector pattern and an inverse design pattern.

12. A method comprising:
receiving a broadband signal source, by a broadband grating coupler,
the broadband grating coupler comprising:
an input coupling comprising an input waveguide layer, the input coupling configured to receive the broadband signal source;
an input grating structure on the input coupling;
an output coupling comprising an output waveguide layer, the output coupling configured to output discrete wavelengths; and
an output grating structure on the output coupling,
wherein at least one of the input grating structure and the output grating structure is an apodized grating structure, the apodized grating structure comprising a plurality of grating elements whose pitch changes along a length of the at least one input grating structure and output grating structure;
diffracting the broadband signal source through the input grating structure resulting in an emitted beam;
projecting the emitted beam on a reflection target, wherein the reflection target is above the input coupling and the output coupling;
receiving, by the output grating structure, a reflected beam from the reflection target, resulting in an output signal;
guiding the output signal through the output waveguide layer of the output coupling; and
emitting the output signal from the output coupling.

13. The method of claim 12, further comprising collecting the output signal from output coupling by an imaging unit to determine if the reflection target is in alignment, wherein the reflection target is an alignment feature on a silicon wafer under manufacture.

14. The method of claim 12, further comprising operating the broadband grating coupler in at least one region of guided-mode resonance (GMR), wherein the broadband grating coupler apparatus is configured to operate in regions of guided-mode resonance (GMR), wherein GMR occurs when at least one of:
the input grating structure and the input waveguide layer are in close proximity and a projected angle of a diffracted broadband signal source traveling into the input waveguide layer matches the angle of a propagated light of the broadband signal source traveling in guided mode in the input waveguide layer; and
the output grating structure and the output waveguide layer are in close proximity and projected angle of the diffracted broadband signal source traveling into the output waveguide layer matches the angle of the propagated light of the broadband signal source traveling in guided mode in the output waveguide layer.

15. The method of claim 12, further comprising operating the broadband grating coupler in at least one region of guided-mode resonance (GMR), wherein the broadband grating coupler apparatus is configured to operate in regions of guided-mode resonance (GMR), wherein GMR occurs when the apodized grating structure exhibits characteristics expressed as:
$$\frac{{λ}_{min}}{Λ} = \{ \begin{matrix}\frac{{n}_{1} sin {θ}_{inc} - max [ {n}_{1} , {n}_{3} ]}{m sin ϕ} & m < 0 \\ \frac{{n}_{1} sin {θ}_{inc} + max [ {n}_{1} , {n}_{3} ]}{m sin ϕ} & m > 0\end{matrix}$$
$$\frac{{λ}_{max}}{Λ} = \{ \begin{matrix}\frac{{n}_{1} sin {θ}_{inc} - {n}_{2}}{m sin ϕ} & m < 0 \\ \frac{{n}_{1} sin {θ}_{inc} + {n}_{2}}{m sin ϕ} & m > 0\end{matrix}$$
wherein:
λₘᵢₙ is a minimum wavelength of the broadband signal source;
λₘₐₓ is a maximum wavelength of the broadband signal source;
∧ is a grating period of the apodized grating structure;
n₁ is a refractive index of a first transmission medium;
n₂ is the refractive index of a second transmission medium;
n₃ is the refractive index of a third transmission medium;
θ_{inc} is an angle of incidence of the broadband signal source upon the apodized grating structure measured from a grating normal;
φ is an angle between a tangent plane normal of a grating structure tangent plane and a grating pattern normal plane; and
m is an integer representing an order of diffraction.

16. The method of claim 15, wherein the operating region of GMR is defined as:
the minimum wavelength of the broadband signal source being 500 nm;
the maximum wavelength of the broadband signal source being 900 nm;
the refractive index of the first transmission medium being 1;
the refractive index of the second transmission medium being equal to the refractive index of the third transmission medium, both being tunable based in part on a design of the apodized grating structure and greater than 1;
the angle of incidence being tunable based in part on the design of the apodized grating structure; and
the grating period being tunable based in part on the design of the apodized grating structure.

17. The method of claim 12, wherein at least one of the input coupling and the output coupling comprise:
a substrate layer;
an insulator layer deposited above the substrate layer;
a metal reflector layer deposited above the insulator layer, wherein the metal reflector layer comprises at least one of gold, aluminum, and iron; and
at least one of the input grating structure and the output grating structure including a grating layer created on at least one of a top of the input waveguide layer and a top of the output waveguide layer.

18. A method of manufacturing an apodized grating coupler, comprising:
depositing an insulator layer above a substrate layer through plasma-enhanced chemical vapor deposition (PECVD);
depositing a metal in a reflector layer;
stacking the reflective layer above the insulator layer;
depositing silicon nitride above the reflector layer, using low-pressure chemical vapor deposition (LPCVD), to form a waveguide layer;
spin-coating a negative photoresist above the waveguide layer;
patterning the spin-coated negative photoresist using E-beam lithography; and
etching a grating pattern into a top of the waveguide layer to form an apodized grating structure on the apodized grating coupler.

19. The method of claim 18, wherein:
the substrate layer is a silicon substrate layer;
the insulator layer is a silicon dioxide insulator layer; and
the reflector layer includes at least one of gold, aluminum, and iron.

20. The method of claim 18, wherein the grating pattern is shaped in a top view pattern including at least one of: a triangular pattern, a sector pattern, and an inverse design pattern.
